(19) United States
(12) Patent Application Publication
(10) Pub. No.: US 2024/0109209 A1
(43) Pub. Date: Apr. 4, 2024

(54) SHAVER HEAD

(71) Applicant: SHENZHEN ACME ELECTRIC APPLICANCE CO., LTD., Guangdong (CN)

(72) Inventor: Mingyong XIE, Guangdong (CN)

(73) Assignee: SHENZHEN ACME ELECTRIC APPLICANCE CO., LTD., Guangdong (CN)

(21) Appl. No.: 18/326,013

(22) Filed: May 31, 2023

Related U.S. Application Data
(63) Continuation of application No. PCT/CN2022/126424, filed on Oct. 20, 2022.

(30) Foreign Application Priority Data
Sep. 29, 2022 (CN) 202211189458.7

(51) Int. Cl. B26B 19/04; B26B 19/38

(52) U.S. Cl. CPC B26B 19/046; B26B 19/3846

(57) ABSTRACT

A shaver head includes a movable blade assembly, a movable blade holder, a spring assembly, a blade screen support, and a blade screen. An upper end of the movable blade holder is fastened to the movable blade assembly, a bottom surface of the movable blade holder is connected to the spring assembly, the spring assembly is fastened to the blade screen support, the blade screen support is connected to the blade screen, and an inner surface of the blade screen abuts against the movable blade assembly. A blade holder spring and a body spring in the spring assembly fit with parts of the head, so that during operation of the shaver head, when moving downward under impact of an external force, the movable blade assembly acts on the movable blade holder by using elastic recovery forces of the springs.

### CROSS-REFERENCE TO RELATED APPLICATION

This application is a continuation of international PCT application serial no. PCT/CN2022/126424, filed on Oct. 20, 2022, which claims the priority benefit of China application no. 202211189458.7, filed on Sep. 29, 2022. The entirety of each of the above mentioned patent applications is hereby incorporated by reference herein and made a part of this specification.

### TECHNICAL FIELD

The present invention relates to the field of shavers, and in particular, to a shaver head.

### BACKGROUND

With the development of shavers, today, almost every man has one or more shavers. However, the improvement of living standards has made people pay more attention to quality. At present, there are many holes in a screen cover of an electric shaver in the market. Beards or hairs can extend into the holes. A miniature motor driven by electric energy drives blades to move, to cut off, by using a cutting principle, beards or hairs extending into the holes. In the conventional technology, a body and a head are connected by using a plurality of rotating connectors, or a plurality of blades are disposed on a head. Parts for connecting the head are relatively complex and prone to damage. Due to structure characteristics of the parts, flexibility of the head is low. Due to fragility of the parts, the following problem is caused: a poor cutting effect due to uneven stress of the blades, impact on a service life of the shaver due to part damage, or the like.

Therefore, a shaver head urgently needs to be provided to resolve one or more of the foregoing technical problems.

### SUMMARY

To resolve the one or more of the problems in the conventional technology, the present invention provides a shaver head.

The following technical solutions are used in the present invention to achieve the foregoing objective: A shaver head is provided, including a movable blade assembly, a movable blade holder, a spring assembly, a blade screen support, and a blade screen. An upper end of the movable blade holder is fastened to the movable blade assembly, a bottom surface of the movable blade holder is connected to the spring assembly, the spring assembly is fastened to the blade screen support, the blade screen support is connected to the blade screen, and an inner surface of the blade screen abuts against the movable blade assembly, to form a shaver head in which the movable blade holder is directly driven by using an eccentric shaft, the movable blade holder drives the movable blade assembly to reciprocate and the movable blade assembly is evenly stressed.

Blade teeth are disposed in the movable blade assembly, and top ends of the blade teeth always abut against the inner surface of the blade screen, to form cross-cutting, to cut off beards penetrating the blade screen.

A spring support, a blade holder spring, and a body spring are separately disposed in the spring assembly, spring fastening columns are disposed in the spring support, the blade holder spring is fastened to the spring fastening columns and a top end of the blade holder spring abuts against the movable blade holder, and the body spring is fastened to the spring fastening columns and one end of the body spring abuts against a body, so that movable blade assembly are evenly stressed during operation.

In some embodiments, a blade holder sliding portion is disposed in the blade holder spring and abuts against the bottom of the movable blade holder, and a body sliding portion is disposed in the body spring and abuts against the body.

In some embodiments, a blade holder hole is disposed in the middle of the spring support and fits with the movable blade holder, and at least one connecting block is disposed on a side of the spring support.

In some embodiments, a connecting mechanism is disposed at the bottom of the movable blade holder and is capable of penetrating the blade holder hole, and a through hole is disposed inside the connecting mechanism and is connected to the eccentric shaft of the body, so that the movable blade holder can reciprocate.

Beneficial effects of the present invention are as follows: Compared with the conventional technology, in the shaver head of the present invention, an internal structure of the head is innovated, to achieve a better beard shaving effect: 1. In the present invention, the movable blade holder is directly driven by the eccentric shaft, and the movable blade holder drives the movable blade assembly to reciprocate. The head has only one eccentric shaft connected to the body, and has only one movable blade assembly. So, the structure is simpler, the design is more reasonable, and a service life of the head is longer due to part characteristics. 2. The blade holder spring and the body spring in the spring assembly fit with parts of the head, so that during operation of the shaver head, when moving downward under impact of an external force, the movable blade assembly acts on the movable blade holder by using elastic recovery forces of the springs, so that the movable blade assembly is evenly stressed. Therefore, a beard shaving effect is better, and user experience is better.

### BRIEF DESCRIPTION OF DRAWINGS

FIG. 1 is an exploded view according to a preferred embodiment of the present invention;

FIG. 2 is a schematic diagram of a structure of a spring assembly according to a preferred embodiment of the present invention;

FIG. 3 is a schematic diagram of a structure of a movable blade holder according to a preferred embodiment of the present invention;

FIG. 4 is a schematic diagram of a structure of a movable blade assembly according to a preferred embodiment of the present invention;

FIG. 5 is a schematic diagram of a structure of a blade screen support according to a preferred embodiment of the present invention;

FIG. 6 is a schematic diagram of a structure of a shaver head according to a preferred embodiment of the present invention; and

FIG. 7 is a schematic diagram of a cross-sectional structure of a shaver head according to a preferred embodiment of the present invention.

### DESCRIPTION OF EMBODIMENTS

To make the foregoing objective, features, and advantages of the present invention clearer and more comprehensible, specific implementations of the present invention are described in detail below with reference to the accompanying drawings. In the following description, numerous specific details are set forth to facilitate a thorough understanding of the present invention. However, the present invention can be implemented in many other ways different from those described herein, and persons skilled in the art can make similar improvements without departing from the connotation of the present invention. Therefore, the present invention is not limited by the specific embodiments disclosed below.

It should be noted that, in the description of this application, orientation or position relationships or quantity relationships indicated by the terms “center”, “upper”, “lower”, “front”, “rear”, “left”, “right”, “top”, “bottom”, “inner”, “outer”, “one”, “a plurality of”, and the like are orientation or position relationships or quantity relationships shown based on the accompanying drawings, and are merely for ease of describing this application and simplifying the description, and are not for indicating or implying that the indicated apparatus or element should have a specific orientation or should be constructed and operated in the specific orientation, or indicating or implying a quantity of technical features, and therefore cannot be construed as a limitation on this application.

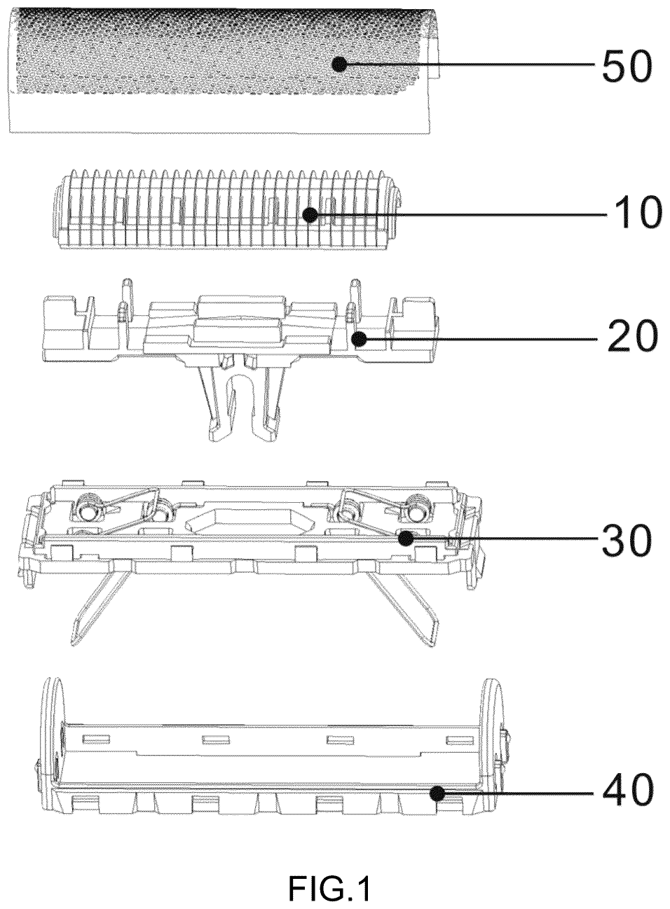

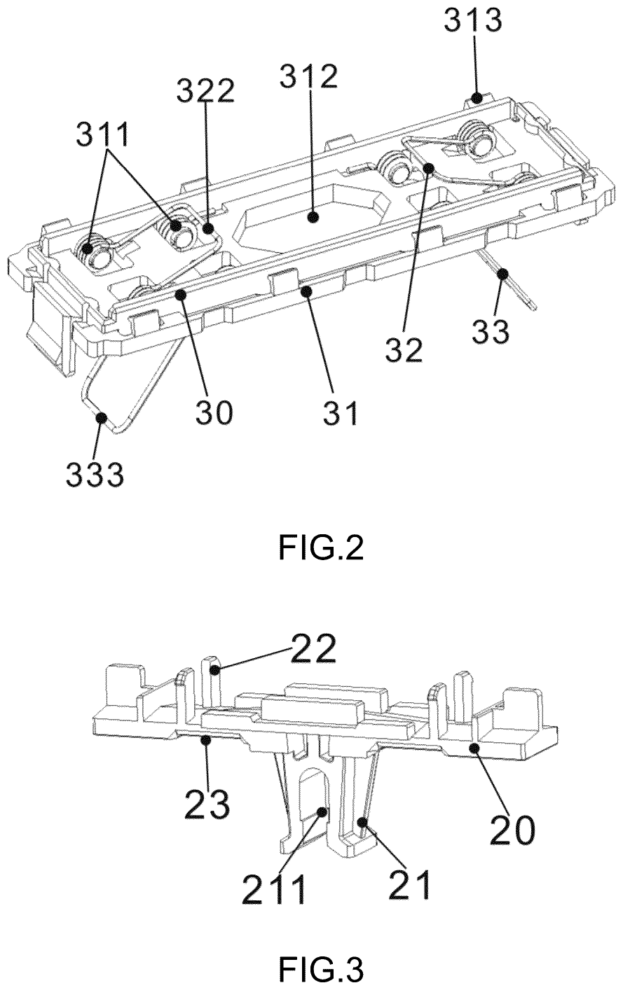

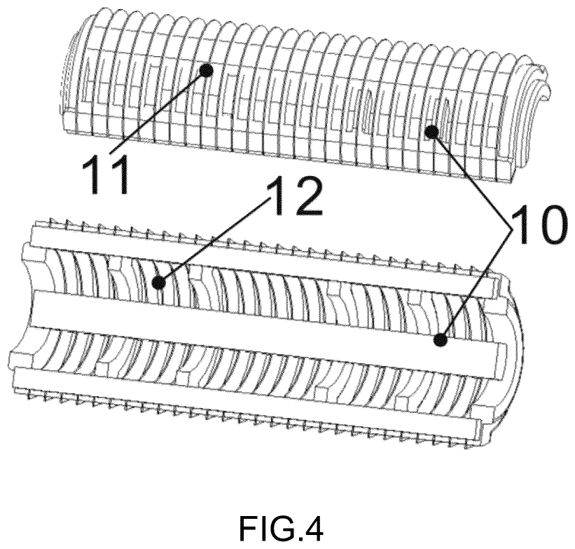

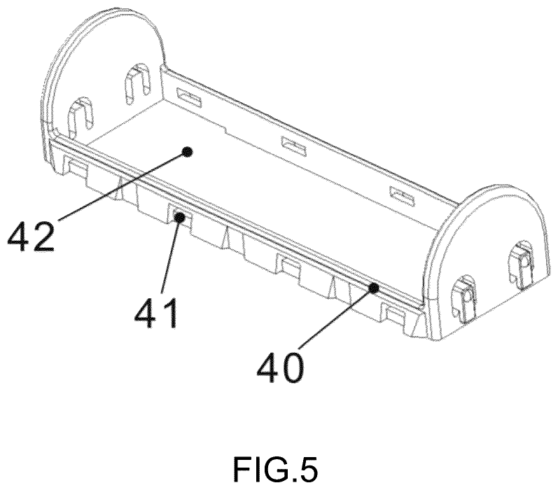

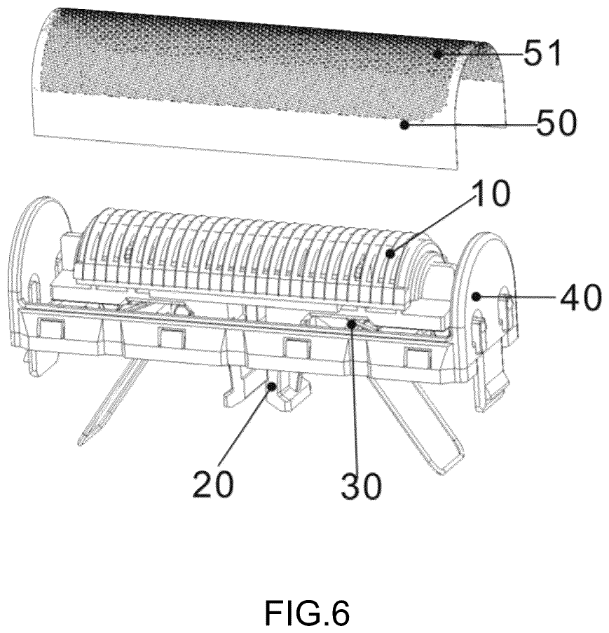

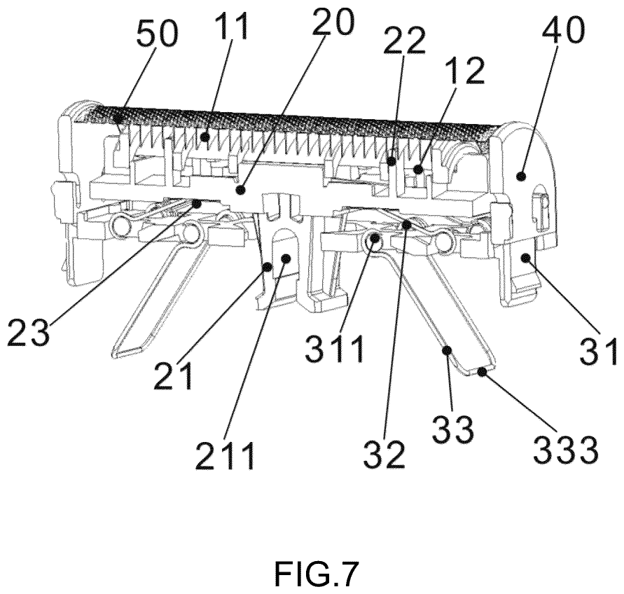

As shown in FIG. 1 to FIG. 7, the present invention provides a shaver head, including a movable blade assembly 10, a movable blade holder 20, a spring assembly 30, a blade screen support 40, and a blade screen 50. An upper end of the movable blade holder 20 is fastened to the movable blade assembly 10, a bottom surface of the movable blade holder 20 is connected to the spring assembly 30, the spring assembly 30 is buckled with the blade screen support 40, the blade screen support 40 is connected to the blade screen 50, and an inner surface of the blade screen 50 abuts against the movable blade assembly 10, to form a shaver head in which the movable blade holder 20 is directly driven by using an eccentric shaft, to drive the movable blade assembly 10 to reciprocate and the movable blade assembly 10 is evenly stressed.

Blade teeth 11 are disposed in the movable blade assembly 10, and top ends of the blade teeth 11 always abut against the inner surface of the blade screen 50, to form cross-cutting, to cut off beards penetrating the blade screen 50.

A spring support 31, a blade holder spring 32, and a body spring 33 are separately disposed in the spring assembly 30, spring fastening columns 311 are disposed in the spring support 31, the blade holder spring 32 is fastened to the spring fastening columns 311 and a top end of the blade holder spring 32 abuts against the movable blade holder 20, and the body spring 33 is fastened to the spring fastening columns 311 and one end of the body spring 33 abuts against a body, so that the movable blade assembly 10 is evenly stressed during operation.

Specifically, the movable blade assembly 10, the movable blade holder 20, and the spring assembly 30 are located between the blade screen support 40 and the blade screen 50. The blade teeth 11 are disposed in the movable blade assembly 10, beard entry holes 51 are disposed in the blade screen 50, and the blade teeth 11 abut against inner surfaces of the beard entry holes 51. When moving, the movable blade assembly 10 forms cutting with the blade screen 50 to generate a cutting force to cut off beards.

A plurality of limiting blocks 22 are disposed at the upper end of the movable blade holder 20, a plurality of limiting grooves 12 are disposed inside the movable blade assembly 10, and the limiting blocks 22 are buckled with the limiting grooves 12. Therefore, when moving under the action of the eccentric shaft of a motor, the movable blade holder 20 can drive the movable blade assembly 10 to reciprocate.

A blade holder hole 312 is disposed in the spring support 31, a connecting mechanism 21 is disposed in the movable blade holder 20, the connecting mechanism 21 directly penetrates the blade holder hole 312, a through hole 211 is disposed in the connecting mechanism 21, and a top end of the eccentric shaft of the motor is directly located in the through hole 211 and always does not deviate from the through hole 211. When starting to operate, the eccentric shaft of the motor enables the movable blade holder 20 to move accordingly.

The movable blade holder 20 is located between the movable blade assembly 10 and the spring assembly 30. A plurality of spring fastening columns 311 are disposed in the spring support 31, to fasten the blade holder spring 32 and the body spring 33. A blade holder sliding portion 322 is disposed in the blade holder spring 32. The blade holder sliding portion 322 abuts against a sliding surface 23 of the movable blade holder, and a movement track of the blade holder sliding portion 322 does not deviate from the sliding surface 23. A body sliding portion 333 is disposed in the body spring 33. The body sliding portion 333 abuts against the body. The same blade holder spring 32 is disposed on each of a left side and a right side of the spring support 31. When the movable blade assembly 10 is forced to move downward when the movable blade assembly 10 receives a downward external force, helical portions of the blade holder spring 32 and the body spring 33 are securely fastened to the spring fastening columns 311, and elastic recovery forces are continuously generated and respectively act on the blade holder sliding portion 322 and the body sliding portion 333. Blade holder springs 32 on the left side and the right side of the spring support 31 are consistent in size and therefore act on the movable blade holder 20 at a same effect. Body springs 33 are consistent in size and therefore act on the body at a same effect, and then react on the movable blade holder 20, so that the movable blade assembly 10 is evenly stressed.

A plurality of connecting blocks 313 are disposed on a side of the spring support 31, and a plurality of connecting buckles 41 are disposed on a side of the blade screen support 40. The connecting blocks 313 and the connecting buckles 41 are buckled through mutual fitting, so that the spring assembly 30 is mounted on the blade screen support 40. The blade screen 50 is directly mounted on the blade screen support 40. The blade teeth 11 of the movable blade assembly 10 abut against the inner surfaces of the beard entry holes 51 of the blade screen 50. The limiting blocks 22 of the movable blade holder 20 are buckled with the limiting grooves 12 of the movable blade assembly 10. The connecting mechanism 21 of the movable blade holder 20 penetrates the blade holder hole 312 of the spring support 31 and then penetrates a support hole 42 of the blade screen support 40, and is connected to the eccentric shaft of the body. The blade holder sliding portion 322 of the blade holder spring 32 abuts against and always does not deviate from the sliding surface 23 of the movable blade holder 20, and the body sliding portion 333 of the body spring 33 always abuts against the body. Therefore, the movable blade holder 20 is directly driven by using the eccentric shaft, and acts on the movable blade assembly 10, to enable the movable blade assembly 10 to reciprocate; and the movable blade assembly 10 is evenly stressed, to achieve a better beard shaving effect.

In some embodiments, the blade holder sliding portion 322 is disposed in the blade holder spring 32 and abuts against the bottom of the movable blade holder 20, and the body sliding portion 333 is disposed in the body spring 33 and abuts against the body.

It should be noted that, during implementation, one blade holder spring 32 is disposed on each of the left side and the right side, and the blade holder springs 32 are consistent in size and therefore act on the movable blade holder 20 at a same effect. One body spring 33 is disposed on each of the left side and the right side, and the body springs 33 are consistent in size and therefore act on the body at a same effect. Based on characteristics of the springs, the springs finally act on the movable blade assembly 10, so that movable blade assembly 10 is evenly stressed, to achieve a better shaving effect.

In some embodiments, the blade holder hole 312 is disposed in the middle of the spring support 31 and fits with the movable blade holder 20, and at least one connecting block 313 is disposed on the side of the spring support 31.

Specifically, the connecting mechanism 21 disposed in the movable blade holder 20 penetrates the blade holder hole 312 and then penetrates the holder hole 42 of the blade screen support 40, and the top end of the eccentric shaft of the body is located in and always does not deviate from the through hole 211 of the connecting mechanism 21. The plurality of connecting blocks 313 disposed on the side of the spring support 31 and the plurality of connecting buckles 41 disposed on the side of the blade screen support are buckled through mutual fitting.

In some embodiments, the connecting mechanism 21 is disposed at the bottom of the movable blade holder 20 and is capable of penetrating the blade holder hole 312, and the through hole 211 is disposed inside the connecting mechanism 21 and is connected to the eccentric shaft of the body, so that the movable blade holder 20 can reciprocate.

An operating principle is as follows: When the shaver head operates, the eccentric shaft of the motor of the body rotates. The eccentric shaft is disposed inside the through hole 211, the through hole 211 is disposed inside the connecting mechanism 21, and the connecting mechanism 21 belongs to the movable blade holder 20. Therefore, the eccentric shaft rotates to drive the movable blade holder 20 to reciprocate.

In this case, the plurality of limiting blocks 22 are disposed at the upper end of the movable blade holder 20, the plurality of limiting grooves 12 are disposed inside the movable blade assembly 10, and the limiting blocks 22 are buckled with the limiting grooves 12. Therefore, when moving under the action of the eccentric shaft of the motor, the movable blade holder 20 can drive the movable blade assembly 10 to reciprocate.

The blade teeth 11 are disposed in the movable blade assembly 10, the beard entry holes 51 are disposed in the blade screen 50, and the blade teeth 11 abut against the inner surfaces of the beard entry holes 51. When moving, the movable blade assembly 10 forms cutting with the blade screen 50 to generate a cutting force to cut off beards.

In this case, objects such as the beards generate a downward acting force, to force the movable blade assembly 10 to move downward. In this case, according to ingenious design and characteristics of the spring assembly 30, the plurality of spring fastening columns 311 are disposed in the spring support 31, to fasten the blade holder spring 32 and the body spring 33. The blade holder sliding portion 322 is disposed in the blade holder spring 32. The blade holder sliding portion 322 abuts against the sliding surface 23 of the movable blade holder, and the movement track of the blade holder sliding portion 322 does not deviate from the sliding surface 23. The body sliding portion 333 is disposed in the body spring 33. The body sliding portion 333 abuts against the body. The same blade holder spring 32 is disposed on each of the left side and the right side of the spring support 31. When the movable blade assembly 10 is forced to move downward when the movable blade assembly 10 receives a downward external force, the helical portions of the blade holder spring 32 and the body spring 33 are securely fastened to the spring fastening columns 311, and elastic recovery forces are continuously generated and respectively act on the blade holder sliding portion 322 and the body sliding portion 333. The blade holder springs 32 on the left side and the right side of the spring support 31 are consistent in size and therefore act on the movable blade holder 20 at a same effect. The body springs 33 are consistent in size and therefore act on the body at a same effect, and then react on the movable blade holder 20, so that the movable blade assembly 10 is evenly stressed during beard shaving, to achieve a better cutting effect.

In summary, the present invention has the following advantages:
1. In the present invention, the movable blade holder 20 is directly driven by using the eccentric shaft, to drive the movable blade assembly 10 to reciprocate. The head has only one eccentric shaft connected to the body, and has only one moving blade part. The structure is simpler, the design is more reasonable, and a service life of the head is longer due to part characteristics.
2. The blade holder spring 32 and the body spring 33 in the spring assembly 30 fit with parts of the head, so that during operation of the shaver head, when moving downward under impact of an external force, the movable blade assembly 10 acts on the movable blade holder 20 by using elastic recovery forces of the springs, so that the moving blades are evenly stressed. Therefore, a beard shaving effect is better, and user experience is better.

The foregoing embodiments merely describe one or more implementations of the present invention, and description of the one or more implementations is relatively specific and detailed, but shall not be understood as a limitation on the patent scope of the present invention. It should be noted that persons of ordinary skill in the art may further make several variations and improvements without departing from the idea of the prevent invention, and the variations and improvements shall fall within the protection scope of the present invention. Therefore, the patent protection scope of the present invention should be subject to the appended claims.

What is claimed is:

1. A shaver head, comprising a movable blade assembly, a movable blade holder, a spring assembly, a blade screen support, and a blade screen, wherein an upper end of the movable blade holder is fastened to the movable blade assembly, a bottom surface of the movable blade holder is connected to the spring assembly, the spring assembly is fastened to the blade screen support, the blade screen support is connected to the blade screen, and an inner surface of the blade screen abuts against the movable blade assembly, to form a shaver head in which the movable blade holder is directly driven by using an eccentric shaft, the movable blade holder drives the movable blade assembly to reciprocate and the movable blade assembly is evenly stressed;
blade teeth are disposed in the movable blade assembly, and top ends of the blade teeth always abut against the inner surface of the blade screen, to form cross-cutting, to cut off beards penetrating the blade screen; and
a spring support, a blade holder spring, and a body spring are separately disposed in the spring assembly, spring fastening columns are disposed in the spring support, the blade holder spring is fastened to the spring fastening columns and a top end of the blade holder spring abuts against the movable blade holder, and the body spring is fastened to the spring fastening columns and one end of the body spring abuts against a body, so that the movable blade assembly is evenly stressed during operation.

2. The shaver head according to claim 1, wherein a blade holder sliding portion is disposed in the blade holder spring and abuts against the bottom of the movable blade holder, and a body sliding portion is disposed in the body spring and abuts against the body.

3. The shaver head according to claim 1, wherein a blade holder hole is disposed in the middle of the spring support and fits with the movable blade holder, and at least one connecting block is disposed on a side of the spring support.

4. The shaver head according to claim 1, wherein a connecting mechanism is disposed at the bottom of the movable blade holder and is capable of penetrating the blade holder hole, and a through hole is disposed inside the connecting mechanism and is connected to the eccentric shaft of the body, so that the movable blade holder is capable of reciprocating.

5. The shaver head according to claim 3, wherein a connecting mechanism is disposed at the bottom of the movable blade holder and is capable of penetrating the blade holder hole, and a through hole is disposed inside the connecting mechanism and is connected to the eccentric shaft of the body, so that the movable blade holder is capable of reciprocating.
